(19) United States
(12) Patent Application Publication
(10) Pub. No.: US 2026/0314698 A1
(43) Pub. Date: Oct. 15, 2026

(54) CONSUMABLE CLASSIFICATION BASED ON HARDNESS OF PLUG ELEMENT

(71) Applicant: Philip Morris Products S.A., Neuchatel (CH)

(72) Inventors: Jérôme Christian COURBAT, Cortaillod (CH); Laurent Serge LAVANANT, Evian-les-Bains (FR); Emmanuel Gérard René ROUGET, Fontaines (CH); Julien VIDAL, Peseux (CH)

(73) Assignee: Philip Morris Products S.A., Neuchatel (CH)

(21) Appl. No.: 19/481,461

(22) PCT Filed: May 8, 2024
(86) PCT No.: PCT/EP2024/062798

§ 371 Date: Nov. 4, 2025

(30) Foreign Application Priority Data
May 12, 2023 (EP) 23173066.4

(51) Int. Cl. A24F 40/53; A24D 1/20; A24F 40/20; A24F 40/51; H05B 1/02

(52) U.S. Cl. CPC A24F 40/53; A24D 1/20; A24F 40/20; A24F 40/51; H05B 1/0252

(57) ABSTRACT

An aerosol-generating device is provided, including: a cavity configured to receive an aerosol-generating article including an aerosol-forming substrate, and a hardness detector configured to detect a hardness of a portion of the aerosol-generating article, the portion of the aerosol-generating article including a front plug, and the hardness detector being further configured to detect a hardness of a portion of the front plug along a longitudinal axis of the front plug of the aerosol-generating article. An aerosol-generating system including the aerosol-generating device and an aerosol-generating article is also provided. A method for identifying an aerosol-generating article in an aerosol-generating device is also provided.

The present invention relates to an aerosol-generating device, an aerosol-generating article, an aerosol-generating system and a method for identifying an aerosol-generating article.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. Aerosol-generating devices are typically designed to operate best when used with an original and specifically designed aerosol-generating article. Furthermore, manufacturers of aerosol-generating articles may offer a product line of an aerosol-generating article in a variety of types with different characteristics, such as flavor or nicotine content.

It would be desirable to provide an aerosol-generating device capable of identifying an aerosol-generating article. It would be desirable to provide an aerosol-generating device capable of detecting an authorized aerosol-generating article. It would be desirable to provide an aerosol-generating device capable of detecting an aerosol-generating article with enhanced reliability. It would be desirable to provide an aerosol-generating device with improved detection capabilities. It would be desirable to have an aerosol-generating device providing an optimized user experience. It would be desirable to have an aerosol-generating article enabling improved identification by an aerosol-generating device.

According to a first aspect of the invention there is provided an aerosol-generating device comprising a cavity and/or a hardness detector. The cavity may be configured for receiving an aerosol-generating article comprising an aerosol-forming substrate. The hardness detector may be configured for detecting a hardness of a portion, optionally a distal portion, of the aerosol-generating article.

According to another aspect, there is provided an aerosol-generating device comprising, a cavity for receiving an aerosol-generating article comprising aerosol-forming substrate, and a hardness detector configured to detect the density of a portion of the aerosol-generating article.

An aerosol-generating article may comprise a plurality of elements, including one or more of a mouthpiece, a spacer, a hollow acetate tube, a sensorial media plug and a front plug. All elements may be connected to each other by an outer wrapper. An aerosol-generating article may have a cylindrical shape.

The front plug may be used as an end portion of the aerosol-generating article. The front plug may be used to ensure that the sensorial media is retained within the aerosol-generating article. The front plug may be made from a material that allows air to be drawn through the front plug. The front plug may be made from a material having an adequate porosity. The front plug may be made from a filter material. The front plug may be made from cellulose acetate tow. The front plug may be made from one or more materials selected from the group comprising ceramic, polymer, biopolymer, metal, zeolite, paper, cardboard, inert material, and inorganic material.

The hardness detector may be configured for detecting a hardness of any plug element of a portion, such as a distal portion, of the aerosol-generating article.

The hardness detector may be configured for detecting a hardness of a front plug of an aerosol-generating article. For the sake of simplicity, in the following we will mainly refer only to the front plug, when the hardness detection is described. However, it is to be understood that to achieve the objective of the invention, the hardness of any element of an inserted aerosol-generating article may be detected.

The hardness detector may detect the hardness of the portion, e.g. the distal portion, of the aerosol-generating article by mechanical, electro-mechanical or optical means.

The hardness detector may be configured to detect the hardness of a portion or section of the front plug of the aerosol-generating article. The hardness detector may be configured to detect the hardness of a portion or section of the front plug of the aerosol-generating article along the longitudinal axis of the aerosol-generating article.

The hardness detector may be configured to engage with a front face of the front plug at the distal end of the aerosol-generating article, when the aerosol-generating article is received in the cavity of the aerosol-generating device. The hardness detector may be provided at the bottom surface of the cavity of the aerosol-generating device. Upon correct insertion of an aerosol-generating article, the hardness detector may come into contact with the front face of the front plug of the aerosol-generating article. In this way the hardness of a portion of the front plug of the aerosol-generating article along the longitudinal axis of the aerosol-generating article may be determined.

The hardness detector may comprise one or more biased pins, such as spring-loaded pins. The hardness detector may comprise one or more displacement sensors. Each displacement sensor may comprise a pogo pin. The one or more displacement sensors may be located in the cavity of the aerosol-generating device. The one or more displacement sensors may be located at the bottom of the cavity of the aerosol-generating device. The one or more displacement sensors are configured to contact a portion, such as the distal portion, of the aerosol-generating article, when the aerosol-generating article is received in the cavity of the aerosol-generating device.

The orientation of the one or more displacement sensors may be parallel, or perpendicular, to the insertion direction of the aerosol-generating article into the cavity. The orientation of the one or more displacement sensors may be parallel, or perpendicular, to the longitudinal axis of the cavity. For instance, the length dimension of the one or more displacement sensors may be parallel, or perpendicular, to the insertion direction and/or longitudinal axis of the cavity.

Upon insertion of the aerosol-generating article the front plug at the distal end of the aerosol-generating article comes into contact with the one or more displacement sensors. The displacement sensor is compressed by the fully inserted aerosol-generating article. The amount of the compression of a given displacement sensor depends on the hardness of the front plug. The compression of the displacement sensor may be used as a measure for the hardness of the front plug.

A displacement sensor may comprise a body, biasing means and a plunger. The biasing means may comprise a spring. The body may contain a lower portion of the plunger and the spring. The spring may be arranged to contact the lower portion of the plunger. The spring may be arranged to bias the plunger against a retaining portion of the body. When no external force is applied to the displacement sensor, the spring is fully extended. The plunger is then in the fully extracted position and is pressed against the retaining portion of the body. When a force is applied to the displacement sensor, the spring is compressed and the plunger moves inside the body.

When used in an aerosol-generating device as described herein, the plunger of the displacement sensor functions as an indenter to penetrate the front plug of the inserted aerosol-generating article. The penetration depth of the plunger depends on the spring load of the displacement sensor and the hardness of the contact part of the front plug. If the spring load of a displacement sensor is known, the penetration depth may be used as a measure of the hardness of the contact part of the front plug.

The one or more displacement sensors may have a first portion extending in a first direction, and a second portion extending in a second direction, the first direction perpendicular to the second direction. When present, the one or more pogo pins may include a right angle pogo pin or an L-root end pogo pin.

The body of the displacement sensors and the plunger may be made from copper or brass. The plunger may be a coated plunger. The material for the coating layer may be gold or silver or any highly conductive material. The spring may be made from a hard material. The spring may be made from stainless steel.

The length of the displacement sensor may range from 5 to 9 millimeters. The length of the displacement sensor may preferably amount to about 7 millimeters.

The length of the plunger may range from 1 to 3 millimeters. The length of the plunger may preferably amount to about 2 millimeters. The diameter of the plunger may range from 0.2 to 2 millimeters. The diameter of the plunger may preferably amount to about 1 millimeter.

The length of the body may range from 3 to 6 millimeters. The length of the body may preferably amount to about 5.3 millimeters. The diameter of the body may range from 1.5 to 3 millimeters. The diameter of the body may preferably amount to about 2.5 millimeter.

The aerosol-generating device may comprise a sensing system to detect the penetration depth of each of the one or more displacement sensors into the front plug. The sensing system may comprise a transducer arrangement to convert the displacement of each of the one or more displacement sensors into an electric signal corresponding to the penetration depth of each displacement sensor.

The aerosol-generating device may comprise a controller. The sensing system may be connected to the controller. The sensing system may be configured to transmit the electric signal corresponding to the penetration depth of each displacement sensor to the controller. The controller may be configured to analyze the electric signal provided by the transducer arrangement. The controller may determine the hardness of the front plug based on an analysis of the electric signal provided by the transducer arrangement. The hardness of the front plug of the aerosol-generating article may be indicative of the type of the inserted aerosol-generating article.

The controller may comprise a memory. The memory may comprise pre-stored reference data. The reference data may comprise reference signals of the sensing system. Each of such reference signals may correspond to a front plug having a specified hardness, or specified plunger displacement.

The controller may be configured to compare the electrical signal provided form the sensing system with the pre-stored reference data. The controller may be configured to correlate the electrical signal provided form the sensing system with the pre-stored reference data. The controller may be configured to detect and identify the type of the inserted aerosol-generating article by correlating the electrical signal provided form the sensing system with the pre-stored reference data. In this way the controller may be configured to identify the aerosol-generating article inserted into the cavity of the aerosol-generating device.

The transducer arrangement for determining displacement of a displacement sensor may include an inductive, a resistive, a capacitive, an optical or a mechanic force sensing mechanism.

The transducer arrangement for determining displacement of a displacement sensor may include a sensing coil arranged around the displacement sensor and a magnet provided at the plunger of the displacement sensor. The magnet may be provided at a lower portion of the plunger. The sensing coil may be wound around the body of the displacement sensor. Upon movement of the plunger carrying the magnet with respect to the sensing coil, an electric signal is inductively induced in the sensing coil. This electric signal may be provided to the controller. The controller may use this electric signal as a measure for the relative movement of the plunger and may analyze this electric signal accordingly.

In more detail, by relative movement of the magnet with respect to the sensing coil, an electric signal is induced in the sensing coil by the physical movement of the magnetic flux inside of it. The intensity and the polarity of the induced electric signal may then be analyzed by the control unit.

In addition or alternatively, the transducer arrangement for determining displacement of a displacement sensor may include an optical sensing mechanism. An optical sensing mechanism may comprise an optical sensor and optionally a light source. The optical sensor may be arranged such that it is sensitive to the movement of the plunger. In this way the electrical signal generated by this sensor may be used as a measure for the movement of the plunger and, thus, as a measure for the penetration depth of the plunger.

The transducer arrangement for determining displacement of a displacement sensor may include a mechanical sensing mechanism. Such mechanism may include a force sensor connected to the displacement sensor, preferably to the plunger of the displacement sensor. The hardness detector of the aerosol-generating device may comprise two displacement sensors. The two displacement sensors may both be provided at the bottom surface of the cavity of the aerosol-generating device. The two displacement sensors may be provided offset from each other. The two displacement sensors may be provided such that they contact different portions of the front plug of an aerosol-generating article inserted into the cavity of an aerosol-generating device.

The two displacement sensors may have an identical construction. In particular the two displacement sensors may have the same mechanical configuration. Such identical displacement sensors provide identical response when an identical external force is applied thereon. Hardness detectors based on two identical displacement sensors may preferably be used together with aerosol-generating articles having a front plug with contact portions made from materials with different hardness. Such aerosol-generating articles will be described in more detail below. When such aerosol-generating articles are used, the penetration depth of the two displacement sensors may be different. The controller may identify the respective aerosol-generating articles by analysing the detected hardness difference of the front plug.

Alternatively the two displacement sensors may have different mechanical configuration. Displacement sensors having a different mechanical configuration, may respond differently, when an identical external force is applied thereon. In particular when displacement sensors having a different mechanical configuration are used, their respective plunger may penetrate to different depth into the front plug of an aerosol-generating article inserted into the cavity of an aerosol-generating device. In such configuration the hardness of the front plug may be determined by the controller by analysing the difference in the penetration depth of the plungers of the two displacement sensors.

In embodiments comprising two displacement sensors, the transducer arrangement for determining the displacement of the displacement sensor may include a capacitive sensing mechanism. Such capacitive sensing mechanism may particularly be useful for determining the relative displacement between the plungers of the two displacement sensors.

The two displacement sensors may function as a capacitive transducer to measure the capacitive change between the two displacement sensors upon relative movement of the two displacement sensors. In this embodiment the two displacement sensors are used as the two electrodes of a parallel capacitor. The capacitance C of such system is basically given by the overlapping area A of the two displacement sensors separated by the distance D, as indicated in the following equation:

C=ϵoϵrA/D

where ϵo is the vacuum permittivity and ϵr the relative permittivity of the dielectric material of the capacitor. Accordingly, the capacitance C is inversely proportional to the distance D between the two displacement sensors and proportional to the overlapping area A between the two displacement sensors.

A relative displacement of the two displacement sensors along their longitudinal axis, thus, reduces the size of the overlapping area A between the two displacement sensors. A reduced size of the overlapping area A decreases the capacitance C between the two displacement sensors. The change in the measured capacitance C may therefore be used as a measure of the different linear extension of the two displacement sensors. In the same way as described above, the different linear extension may be evaluated to determine a hardness of the filter plug or a hardness difference of two different contact portions of the filter plug. The electric signal provided by a capacitive sensing mechanism may be indicative of a change of the longitudinally overlapping area of the plungers of the displacement sensors.

When the controller applies a given voltage across the two displacement sensors, an initial capacitance C between the two displacement sensors may be determined. Upon insertion of an aerosol-generating article, the springs of the two displacement sensors may be compressed by the aerosol-generating article. Depending on the spring coefficient of the springs of the two displacement sensors and or depending on the hardness of the contact portion of the portion of the aerosol-generating article, the spring compressive level of the two displacement sensors may deviate from each other. The different spring compressive level of the two displacement sensors may cause a reduction of the overlapping area between two displacement sensors. As a result, the capacitance between the two displacement sensors is decreased. The change of the capacitance may be indicative of the hardness of the contact portion or of the hardness difference of the contact portions of a portion of the aerosol-generating article.

The invention may provide means and a method to detect and identify authorized aerosol-generating articles and specific types of aerosol-generating articles received in the aerosol-generating device. The device may be provided with a controller monitoring and processing the signal output of the hardness detector. By comparing the signal output of the hardness detector with pre-stored reference data, the controller may one or more of: (i) determine the presence of an authorized article in the device, (ii) identify the type of the inserted article, (iii) regulate operation of the device in dependence on the characteristics of the inserted aerosol-generating article, and (iv) determine the presence and/or absence of an article in the device.

It will be appreciated that identifying the aerosol-generating article for use with the aerosol-generating device may be useful for a variety of different purposes, and the invention is not limited to any one particular purpose for identifying the aerosol-generating article. For instance, identifying the aerosol-generating article may allow one of a plurality of predetermined heating profiles to be applied that is associated with the identified aerosol-generating article; identifying the aerosol-generating article may allow a user interface of the aerosol-generating device to operate differently in response to identifying the aerosol-generating article, e.g. by displaying a flavour of the aerosol-generating article; and/or identifying the aerosol-generating article may allow a record of consumption of each type of aerosol-generating article used with the aerosol-generating device to be stored at the aerosol-generating device to assist the user in monitoring their usage habits.

Authorized articles may be provided with a portion, such as a distal portion, having a specific hardness. In response to the detection of the authorized article, the controller may enable one or both of operation of the device and provision of a user experience. For example, power may be provided to a heating assembly of the aerosol-generating device. If the device does not detect an authorized article, the device may one or both of prevent operation of the device and provision of a user experience. For example, power being provided to the heating assembly may be prevented.

The invention may allow the provision of an optimized user experience by adapting aerosol generation to the type of article inserted in the device. Articles belonging to a type of article may be provided with a type specific of portion, e.g. a specific type of distal portion, having a specific hardness. By comparing the output signal generated by the hardness detector with pre-stored reference data, the device may identify the article type inserted in the device. In response, the device may adapt and thereby optimize aerosol generation. For example, a pre-stored type specific heating profile may be employed. The type specific heating profile may correspond to a type specific configuration of aerosol-forming substrate within the article.

In use, the article comprising a front plug with specific hardness may be inserted into the cavity of the device by a user. During the insertion, the article in particular the front plug makes contact with the hardness detector. The output of the hardness detector, typically an electric signal may be provided to the controller. The controller may correlate the provided detector output to pre-stored reference data to identify the inserted article. In response, the controller may adjust the operation of the device.

The invention may provide article detection and identification with one or more of an improved reliability and improved consistency. By reducing the risk of erroneous rejection of authorized articles, consumer satisfaction may be enhanced.

The invention may provide article detection and identification which can easily and cost-effectively be realized with existing articles and devices.

In particular, it is sufficient to provide the aerosol-generating articles with a front plug having the desired hardness configuration, such that it can be identified by the controller of the aerosol-generating device. Additional marking or modification of the articles is not required.

Detection of the presence of an authorized aerosol-generating article in the device may prevent or at least reduce the risk of usage of counterfeit and non-authorized articles with the device. Damage to the device may be avoided. Economic losses of authorized article manufacturers may be minimized.

Identification of a specific type of aerosol-generating article in the device may enable the provision of an optimized user experience. For example, an article type specific heating profile may be provided. Aerosol generation may be optimized and adapted according to the article type inserted in the device.

Identification of an aerosol-generating article using hardness measurement may offer versatile use of different types of heating elements.

A longitudinal axis of a component may be an axis along or parallel to the lengthwise direction of the component. A longitudinal axis of the device may extend between the distal end and the proximal end of the device. A longitudinal axis of the article may extend between the distal end and the proximal end of the article.

The device may comprise a heating element, preferably a heating coil.

The one or more displacement sensors may be made of a non-metal material, or another material that is not inductively heat-able.

The heating element may be arranged at least partly, preferably fully, surrounding the cavity. The heating element may be arranged at a distal end of the cavity.

The device may comprise a controller. The controller may be configured for identifying a type of the aerosol-generating article based on an output of the hardness detector. The output of the hardness detector may be an electrical signal.

The controller may comprise a microprocessor, which may be a programmable microprocessor. The controller may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The controller may be configured to monitor the electrical resistance of the heating element, and preferably to control the supply of power to the heating element dependent on the electrical resistance of the heating element.

The controller may be configured to monitor the output of the hardness detector. The controller may be configured to monitor the progression of the output of the hardness detector. The controller may be configured to record the output of the hardness detector. The controller may be configured to process the output of the hardness detector. The controller may be configured to analyse the output of the hardness detector. The controller may be configured to identify the aerosol-generating article by processing the output of the hardness detector. The controller may be connected to the hardness detector. The controller may be configured to communicate with the hardness detector. The controller may be configured to determine the presence and/or absence of an aerosol-generating article by processing the output of the hardness detector. The controller may be configured to permit aerosol to be generated only after determining that an aerosol-generating article is present. The controller may be configured to prohibit aerosol generation, or cease aerosol generating, in response to determining that an aerosol-generating article is absent.

The controller may be configured to regulate power supply to the heating element based on the identification of a type of aerosol-generating article. Upon identification of a type of aerosol-generating article, the controller may allow power to be supplied to the heating element. Upon identification of a type of aerosol-generating article, the controller may allow the provision of a user experience. Upon identification of a type of aerosol-generating article, the controller may adjust the power supply in dependence on the article type identified. The controller may be configured to provide power to the heating element according to a predefined heating profile for the respective identified article.

The controller may adjust the magnitude of power supply in dependence on the article type identified. The controller may adjust the time period of power supply in dependence on the article type identified. The controller may adjust the temperature of the heating element in dependence on the article type identified. The controller may adjust one or more of the amplitude and the frequency of a current supplied to the heating element in dependence on the article type identified. The controller may adjust the signal powering the heating element in dependence on the article type identified.

The memory of the controller may comprise a database of pre-stored heating profiles for each known type of aerosol-generating article. The controller may be configured to provide power according to the heating profile of the identified type of aerosol-generating article. Power supply may be tailored to the configuration of a specific article type. Aerosol-generation and the user experience may be optimized.

The heating element may comprise a heating coil. The heating coil may have a length of between 15 millimeters and 31 millimeters, preferably of between 11 millimeters and 21 millimeters.

In a second aspect, the invention relates to an aerosol-generating article comprising an aerosol-forming substrate in an aerosol-forming substrate portion; and a substrate wrapper at least partly circumscribing the aerosol-forming substrate portion. A portion, such as the distal portion, of the aerosol-generating article is formed such as to have a pre-defined hardness.

A “distal portion” of the aerosol-generating article refers to the portion of the aerosol-generating article that in use may be inserted into the cavity of an aerosol-generating device. The portion of the aerosol-generating article that is not inserted into the cavity of the aerosol-generating device is referred to herein as a “proximal portion” of the of an aerosol-generating article.

An aerosol-generating article may comprise a plurality of elements, including one or more of a mouthpiece, a spacer, a hollow acetate tube, a sensorial media plug and a front plug. All elements may be connected to each other by an outer wrapper. The outer wrapper may preferably be an outer paper wrapper.

An aerosol-generating article may have a cylindrical shape.

The distal portion of the aerosol-generating article may be configured as a front plug. The front plug may be used as an end portion of the aerosol-generating article. The front plug may be used to ensure that sensorial media is retained within the aerosol-generating article during use. The front plug may be made from a material that allows air to be drawn through the front plug. The front plug may be made from a material having an adequate porosity. The front plug may be made from a filter material.

The front plug may have a pre-defined hardness. In embodiments the front plug may be formed to have two different sections. The two different sections may be configured to have a different hardness.

The front plug may include a first section and a second section, wherein the first section and the second section are placed in a concentric arrangement along the longitudinal axis of the aerosol-generating article. The first section may be configured as a central section of the front plug. The second section may be configured to surround the first section.

Each section of the front plug may be formed from one or more materials. These one or more materials may be selected from the group comprising cellulose acetate tow, ceramic, polymer, biopolymer, metal, zeolite, paper, cardboard, inert material, and inorganic material. By manufacturing the two sections to have different hardness, specific types of aerosol-generating articles may be distinguished from each other. By defining the front plug sections to each assume one of three different hardness values, already 9 different combinations of front plug sections are available. Thus, in such case 9 different types of aerosol-generating may be distinguished from each other In a simple implementation of such system, the various front plug section may either be void, soft or hard. A filter section which is void may lead to no significant compression of the corresponding displacement sensor. A filter section which has a high hardness may lead to rather high compression of the corresponding displacement sensor. A filter section which has a low hardness may lead to an intermediate compression of the corresponding displacement sensor.

Of course, more sophisticated combinations of hardness levels for the various filter sections may be possible. Using additional hardness levels may increase the number of possible combinations. It may also be possible to provide filter elements having additional sections which interact with additional displacement sensors in the cavity of the aerosol-generating device.

The term of “hardness” as used herein refers to a characteristic of an element of the aerosol-generating article. “Hardness” is defined as the resistance to indentation. “Hardness” is determined by measuring the permanent depth of the indentation of an indenter. That is to say, when a measuring instrument gives a fixed force and uses a given indenter on a tested material, a lower value of the indentation means that the tested material is hard. The hardness of a tested item may depend on its size, material characteristics and material treatment. The material characteristics include ductility, elastic stiffness, plasticity, strain, strength, toughness, viscoelasticity, and viscosity.

The terms “portion” and “section” with respect to the aerosol-generating article or elements of the aerosol-generating article are used herein synonymously. In particular, the terms “portion of the front plug” and “section of the front plug” are used herein synonymously and are used to refer to dedicated regions of the front plug.

The hardness levels of the front plug or the different section of the front plug may be designed to facilitate identification of aerosol-generating articles as described herein. The hardness measurement may generally be carried out according to the Shore test procedures. The test conditions may be as defined in EN ISO 868 or ASTM D 2240, wherein the hardness of the front plug may be determined based on the penetration depth of a probe, such as a probe of a displacement sensor, when a specific force presses an aerosol-generating article into a cavity of an aerosol-generating device. Different hardness measurement techniques such as the Rockwell hardness test may equally be applied.

The hardness of the first section of the front plug may be higher than the hardness of the second section of the front plug. The hardness of the first section of the front plug may range between 50 and 120 Shore. The hardness of the first section of the front plug may range between 70 and 100 Shore. The hardness of the first section of the front plug may be about 85 Shore.

The hardness of the second section of the front plug may range between 30 and 90 Shore. The hardness of the second section of the front plug may range between 40 and 70 Shore. The hardness of the second section of the front plug may be about 55 Shore.

According to a third aspect, the invention relates to an aerosol-generating system comprising an aerosol-generating device as described herein and an aerosol-generating article.

The aerosol-generating article may be configured as described above. In an embodiment the aerosol-generating article comprises a front plug with two sections having different hardness. The aerosol-generating device is configured to comprise a cavity for receiving the aerosol-generating article. The aerosol-generating device is further configured to comprise a hardness detector comprising two displacement sensors as described above. The two displacement sensors are configured such that each of the two displacement sensors contacts one of the two sections with different hardness, when the aerosol-generating article is received in the cavity of the aerosol-generating device.

The aerosol-generating device may be configured to be used with a plurality of different types of aerosol-generating articles.

In a fourth aspect, the invention relates to a method for identifying an aerosol-generating article in an aerosol-generating device of an aerosol-generating system as described herein. The method comprises detecting, by a hardness detector, the hardness of a portion, optionally a distal portion, of the aerosol-generating article.

The method may be used with an aerosol-generating system comprising an aerosol-generating article with a front plug having two sections with different hardness. The method may further comprise the steps of identifying the aerosol-generating article by determining the hardness of the first and second section of the front plug of the article.

The method may comprise the steps of identifying the aerosol-generating article by detecting a hardness of the portion, such as the distal portion, of an aerosol-generating article and by comparing the output with reference data.

The step of controlling the operation of the aerosol-generating device may include preventing operation of the aerosol-generating device if an unauthorized aerosol-generating article is detected.

The step of controlling the operation of the aerosol-generating device may include choosing a heating profile of the aerosol-generating device depending upon an output of the hardness detector.

As used herein, the terms ‘proximal’, ‘distal’, ‘downstream’ and ‘upstream’ are used to describe the relative positions of components, or portions of components, of the aerosol-generating device and the aerosol-generating article in relation to the direction in which a user draws on the aerosol-generating device or aerosol-generating article during use thereof.

The aerosol-generating system may comprise a mouth end through which in use an aerosol exits the aerosol-generating system and is delivered to a user. The mouth end may also be referred to as the proximal end. In use, a user draws on the proximal or mouth end of the aerosol-generating system in order to inhale an aerosol generated by the aerosol-generating system. The aerosol-generating system comprises a distal end opposed to the proximal or mouth end. The proximal or mouth end of the aerosol-generating system may also be referred to as the downstream end and the distal end of the aerosol-generating system may also be referred to as the upstream end. Components, or portions of components, of the aerosol-generating system may be described as being upstream or downstream of one another based on their relative positions between the proximal, downstream or mouth end and the distal or upstream end of the system.

The aerosol-generating device may comprise a mouth end through which in use an aerosol exits the aerosol-generating device and is delivered to a user. In use, a user draws on the proximal or mouth end of the aerosol-generating device in order to inhale an aerosol generated by the aerosol-generating device. Alternatively, a user may directly draw on an aerosol-generating article inserted into an opening at the proximal end of the aerosol-generating device. The opening at the proximal end may be an opening of the cavity. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may have a length of between 86 millimeters to 130 millimeters.

The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece. The cavity may have a length of between 28 millimeters and 67 millimeters. The cavity may have a diameter of between 8 millimeters and 12 millimeters.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As described, in any of the aspects of the disclosure, the heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni-Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. The susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

The aerosol-generating article may have a total length between 55 millimeters and 110 millimeters, preferably of between 60 millimeters and 90 millimeters. The aerosol-generating article may have an external diameter between 4.5 millimeters and 17 millimeters, preferably between 6 millimeters and 9 millimeters. The aerosol-generating article may comprise a filter plug. The filter plug may be located at a downstream end of the aerosol-generating article. The filter plug may be a cellulose acetate filter plug. The filter plug is approximately 7 millimeters in length in one embodiment, but may have a length of between approximately 5 millimeters to approximately 10 millimeters.

The aerosol-generating article may comprise a separation between the aerosol-forming substrate and the filter plug. The separation may be approximately 18 millimeters, but may be in the range of 5 millimeters to 25 millimeters.

Below, there is provided a non-exhaustive list of non-limiting examples. Any one or more of the features of these examples may be combined with any one or more features of another example, embodiment, or aspect described herein.

Features described in relation to one embodiment may equally be applied to other embodiments of the invention.
Example Ex1. An aerosol-generating device comprising, a cavity for receiving an aerosol-generating article comprising aerosol-forming substrate, and a hardness detector configured to detect the density of a portion, preferably a distal portion, of the aerosol-generating article.
Example Ex2. An aerosol-generating device according to example Ex1, wherein the distal portion of the aerosol-generating article comprises a front plug, and wherein the hardness detector is configured to detect a hardness of the front plug of the aerosol-generating article.
Example Ex3. An aerosol-generating device according to any of the preceding examples, wherein the hardness detector comprises one or more displacement sensors.
Example Ex4. An aerosol-generating device according to any of the preceding examples, wherein the density detector comprises two displacement sensors.
Example Ex5. An aerosol-generating device according to any of the preceding examples, wherein the one or more displacement sensors are located at the bottom of the cavity of the aerosol-generating device.
Example Ex6. An aerosol-generating device according to any of the preceding examples, wherein the one or more displacement sensors are configured to contact a portion of the aerosol-generating article, such as a distal portion of the aerosol-generating article, when the aerosol-generating article is received in the cavity of the aerosol-generating device.
Example Ex7. An aerosol-generating device according to any of the preceding examples, wherein each of the one or more displacement sensors comprise a body, biasing means (e.g., a spring) and a plunger.
Example Ex8. An aerosol-generating device according to any of the preceding examples, wherein the plunger of each of the one or more displacement sensors is configured as an indenter to penetrate the front plug of the inserted aerosol-generating article.

Example Ex 9. An aerosol-generating device according to any of the preceding examples, the aerosol-generating device further comprising a controller and a sensing system to detect the penetration depth of each of the one or more displacement sensors into the front plug.
Example Ex10. An aerosol-generating device according to any of the preceding examples, wherein the sensing system comprises a transducer arrangement to convert the displacement of each of the one or more displacement sensors into an electric signal corresponding to the penetration depth of each displacement sensor.
Example Ex11. An aerosol-generating device according to any of the preceding examples, wherein the controller is configured to analyze the electric signal provided by the transducer arrangement and to thereby identify the aerosol-generating article.
Example Ex12. An aerosol-generating device according to any of the preceding examples, wherein identification of the aerosol-generating article is done by comparing the measured data to pre-stored reference data.
Example Ex13. An aerosol-generating device according to any of the preceding examples, wherein the transducer arrangement for determining displacement of a displacement sensor includes a sensing coil arranged around the displacement sensor and a magnet provided at the plunger of the displacement sensor.
Example Ex14. An aerosol-generating device according to any of the preceding examples, wherein the transducer arrangement determines the displacement of a displacement sensor via the electric signal induced in the sensing coil upon relative movement of the magnet provided at the plunger with respect to the sensing coil.
Example Ex15. An aerosol-generating device according to any of the preceding examples, wherein the transducer arrangement for determining the displacement of a displacement sensor includes an optical sensing mechanism or a force sensing mechanism.
Example Ex16. An aerosol-generating device according to any of the preceding examples, wherein the transducer arrangement for determining the displacement of a displacement sensor includes a capacitive sensing mechanism, wherein the measurement signal is caused by a change of the longitudinally overlapping area of the plungers of the displacement sensors.
Example Ex17. An aerosol-generating article, comprising an aerosol-forming substrate in an aerosol-forming substrate portion; and a substrate wrapper at least partly circumscribing the aerosol-forming substrate portion, wherein a portion, preferably a distal portion, of the aerosol-generating article is formed such as to have a pre-defined hardness.
Example Ex18.The aerosol-generating article according to the preceding example, wherein the distal portion of the aerosol-generating article is formed from a front plug having two sections with different hardness.
Example Ex19. The aerosol-generating article according to the preceding example, wherein the two portions with different hardness are provided in a concentric arrangement.
Example Ex20. The aerosol-generating article according to the preceding example, wherein the two portions with different density are made from one or more of: cellulose acetate tow, ceramic, polymer, biopolymer, metal, zeolite, paper, cardboard, inert material, and inorganic material.
Example Ex21. The aerosol-generating article according to the preceding example, wherein the first portion of the front plug has a hardness of between 50 and 120 Shore, preferably between 70 and 100 Shore and preferably of about 85 Shore.
Example Ex22. The aerosol-generating article according to the preceding example, wherein the second portion of the front plug has a hardness of between 30 and 90 Shore, preferably between 40 and 70 Shore and preferably of about 55 Shore.
Example Ex23. The aerosol-generating article according to the preceding example, wherein the hardness measurement is carried out according to the Shore test procedures under test conditions as defined in EN ISO 868 or ASTM D 2240.
Example Ex24. An aerosol-generating system comprising the aerosol-generating device according to any one of examples 1 to 16 and an aerosol-generating article, preferably according to any one of examples Ex17 to Ex23.
Example Ex25.An aerosol-generating system according to the preceding example, wherein the aerosol-generating article comprises two portions with different hardness, and wherein the two portions with different hardness are configured to make contact to two displacement sensors of the aerosol-generating device, when the aerosol-generating article is received in the cavity of the aerosol-generating device.
Example Ex26. A method for identifying an aerosol-generating article in an aerosol-generating device of an aerosol-generating system, optionally according to any of the preceding examples, wherein the method comprises detecting, by a density detector, the density of a portion, optionally a distal portion, of the aerosol-generating article.
Example Ex27. The method according to the preceding example, further comprising the steps of identifying the aerosol-generating article by determining the difference between the densities of the first and second portion of the front plug of the article and by comparing the density difference with reference data.
Example Ex28. The method according to any of the preceding examples, further comprising the step of controlling operation of the aerosol-generating device depending upon a density detector output.
Example Ex29. The method according to any of the preceding examples, wherein controlling the operation of the aerosol-generating device includes deactivating operation of the aerosol-generating device if an unauthorized aerosol-generating article is detected.
Example Ex30. The method according to any of the preceding examples, wherein controlling the operation of the aerosol-generating device includes choosing a heating profile of the aerosol-generating device depending upon a density detector output.

The invention will be further described, by way of example only, with reference to the accompanying drawings in which:

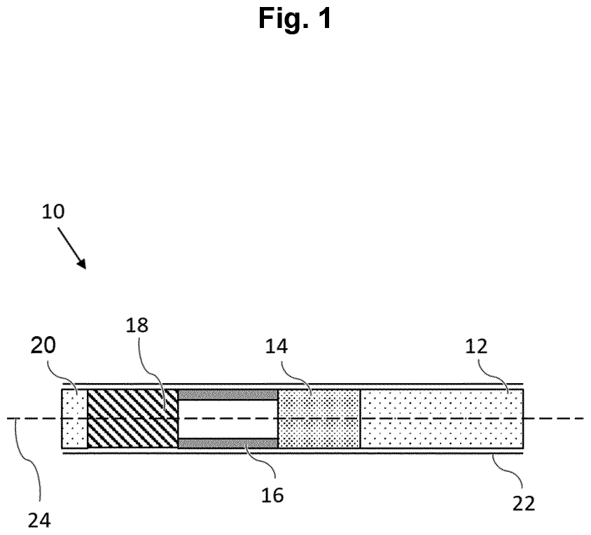

FIG. 1 shows a cross-sectional view of an aerosol-generating article;

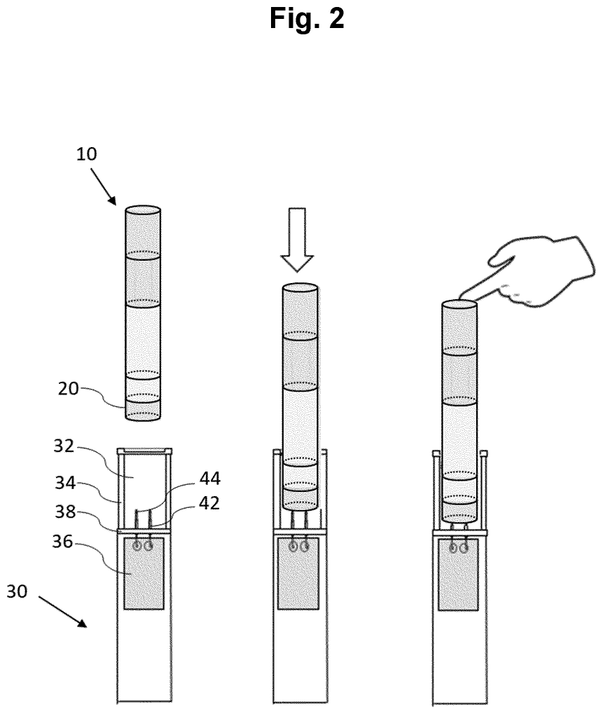

FIG. 2 shows insertion of an aerosol-generating article into a cavity of an aerosol-generating device;

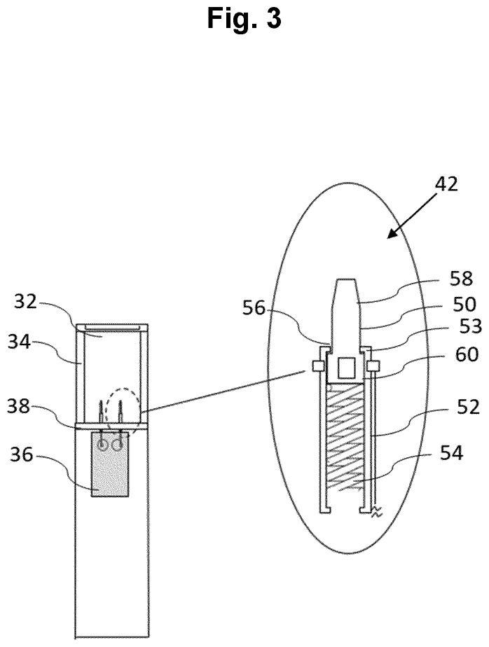

FIG. 3 shows a hardness detector based on a displacement sensor;

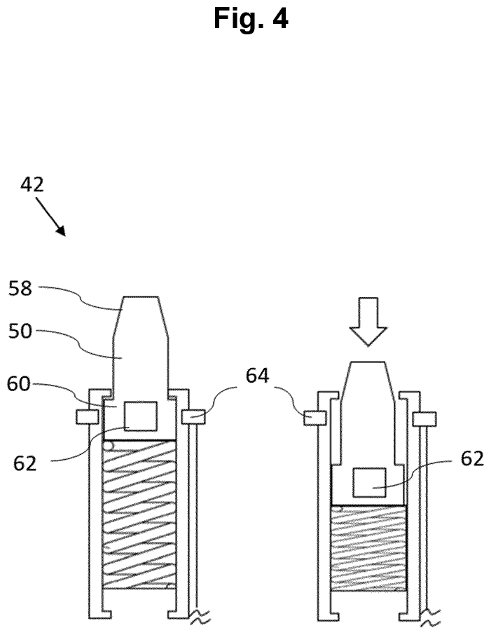

FIG. 4 schematically shows a displacement sensor with inductive transducer arrangement; and

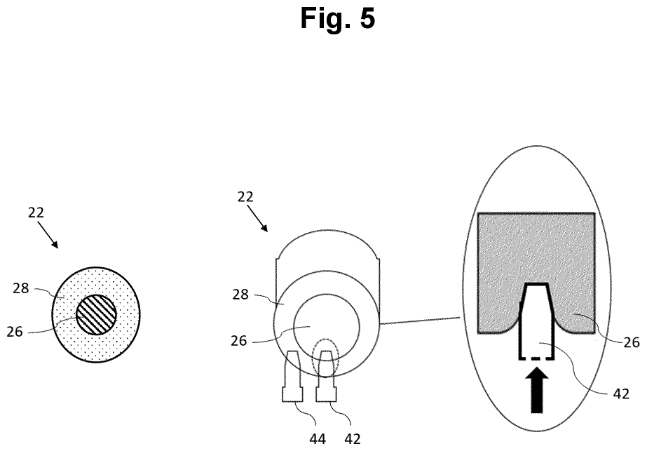

FIG. 5 shows a hardness detector comprising two displacement sensors; and

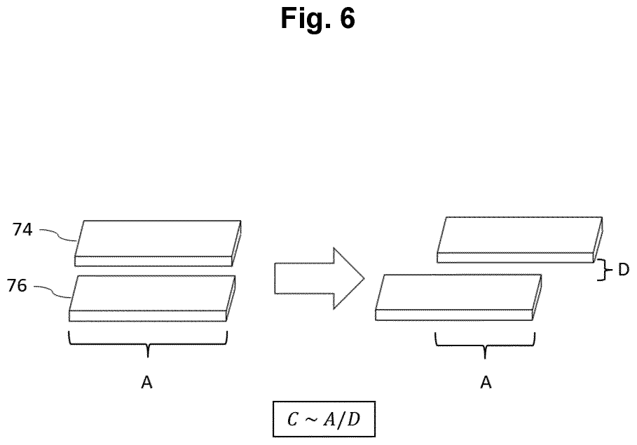

FIG. 6 illustrates an alternative transducer arrangement based on a capacitive measurement.

FIG. 1 shows an aerosol-generating article 10 in a cross-sectional view. The aerosol-generating article 10 comprises a mouth-end filter 12 located at a proximal end of the article 10. The article 10 further comprises a PLA (poly lactic acid) plug 14, a hollow acetate tube 16, and an aerosol-forming substrate portion 18 comprising an aerosol-forming substrate, for example, a gathered sheet of homogenized tobacco. At the distal end of the article 10 there is provided a front plug 20. The article is circumscribed by an outer wrapper 22. A central axis 24 extends centrally along a longitudinal direction of the aerosol-generating article 10.

For generating an aerosol, the aerosol-generating article 10 is inserted into a cavity 32 of an aerosol-generating device 30, as depicted with the series of views of FIG. 2. The cavity 32 defines a heating chamber. The heating chamber comprises a heating element 34. In this case the heating element 34 is an external, resistive heater, which is comprised in the sidewall of the heating chamber. The controller 36 is configured to supply power from a power supply (not shown) to heat the heating element 34. In another example, the heating element 34 is an induction coil that heats a susceptor embedded in the aerosol-forming substrate portion 18.

At the bottom of the cavity 32 of the aerosol generating device 30 there is provided a hardness detector. The hardness detector comprises two displacement sensors 42, 44. Upon insertion of the aerosol-generating article 10 into the cavity 32 of the aerosol-generating device 30, the front plug 20 at the distal end of the aerosol-generating article 10 comes into contact with the displacement sensors 42,44. This is depicted in the middle view of FIG. 2. As the user applies pressure to fully insert the aerosol-generating article 10 into the cavity 32, a hardness detection of a portion of the front plug 20 along the longitudinal axis of the front plug 20 is carried out. This is depicted in the right-hand view of FIG. 2. The output signal of the hardness detector is transmitted to the controller 36. The controller 36 evaluates the output signal of the hardness detector. Such evaluation comprises a verification as to whether the inserted article 10 is an authentic article. In addition, evaluation may comprise an identification of the type of the inserted aerosol-generating article 10. The controller 36 may further be configured to supply power to the heating element 34 according to a pre-defined heating protocol for the identified type of aerosol generating article 10.

The operation principle of the hardness detector is explained in more detail in the context of FIGS. 3 and 4. FIG. 3 shows an enlarged view of a displacement sensor 42 forming a part of the hardness detector at the bottom 38 of the cavity 32 of the aerosol-generating device 30.

The displacement sensor 42 comprises a plunger 50, a body 52, and a spring 54. The body 52 of the displacement sensor 42 is formed in a cylindrical shape. The body 52 is hollow and defines an upper opening 56 through which an upper portion 58 of the plunger 50 may extend. The body 52 is further configured to comprise and retain therein a lower portion 60 of the plunger 50 and the spring 54. The spring 54 is arranged to contact the lower portion 60 of the plunger 52. The spring 54 is further arranged to apply an elastic force to the plunger 50. In the configuration shown in FIG. 3 the displacement sensor 42 is in the fully extend position in which the spring 54 biases the plunger 50 in the most upward position. In this position the lower portion 60 of the plunger 50 engages with a retention element provided at the upper end of the body 52. In the depicted embodiment the retention means is an inwardly protruding surface portion 53, against which the lower portion 60 of the plunger 50 is biased by the spring 54.

Upon application of an external force to the displacement sensor 42, the upper portion 58 of the plunger 50 is moved into the housing. Thereby the spring 54 is compressed. The displacement of the plunger 50 is a measure for the force applied to the displacement sensor 42.

The displacement sensor 42 further comprises a transducer arrangement for determining the displacement of the plunger 50. The transducer arrangement and its function are illustrated in FIG. 4. The transducer arrangement comprises an inductive sensing mechanism. The transducer arrangement includes a magnet 62 provided at the lower portion 60 of the plunger 50 and a sensing coil 64. The sensing coil 64 is located at an upper end of the body 52 of the displacement sensor 42 and is arranged to surround the body 52. In the fully extended position the displacement sensor 42, the magnet 62 at the lower portion 60 of the plunger 50 is positioned at the same horizontal level as the sensing coil 64, as depicted in the left view in FIG. 4. Upon application of an external pressure the plunger 50 and the magnet 62 mounted thereon is moved downwards. Upon movement of the plunger 50 carrying the magnet 62 with respect to the sensing coil 64, an electric signal is inductively induced in the sensing coil 64. The induced electric signal is a measure for the displacement of the plunger 50. This electric signal is provided to the controller 36 of the aerosol-generating device 30. The controller 36 is configured to analyze this electric signal and to control the aerosol-generating device 30 in dependence of the detected electric signal.

The plunger 50 of the displacement sensor 42 is configured to function as an indenter to penetrate the front plug 20 of an aerosol-generating article 10 inserted into a cavity 32 of an aerosol-generating device 30. A front plug 22 having a high hardness leads to a high compression of the displacement sensor 42 and a large displacement of the respective plunger 50. A front plug 22 having a low hardness leads to less compression of the displacement sensor 42 and a smaller displacement of the respective plunger 50.

In the embodiments shown in FIGS. 2 and 3 the hardness detector comprises two displacement sensors 42, 44 arranged parallel to each other and offset from each other at the bottom 38 of the cavity 32 of an aerosol-generating device 30. Such hardness detector may be advantageously used with an aerosol-generating article 10 comprising a front plug 20 with two different sections 26, 28. A cross-section of a front plug with two different sections 26, 28 is shown in FIG. 5. This front plug 20 comprises a first section 26 and a second section 28 in a concentric arrangement along the longitudinal axis of the aerosol-generating article 10. The first section 26 is configured as a central section of the front plug 20. The first section 26 is configured to have a hardness of 85 Shore The second section 28 is configured to surround the first section 26. The second section 28 is configured to have a lower hardness of 55 Shore As shown in FIG. 5, one of the displacement sensors 42 is positioned to engage with the first section 26 of the front plug 20, while the other displacement sensor 44 is configured to engage with the second section 28 of the front plug 20.

Since the two sections 26, 28 of the front plug 20 have different hardness, the displacement of the respective plungers 50 of the displacement sensors 42, 44 will differ correspondingly when an aerosol-generating article 10 is fully inserted into the cavity 32 of the aerosol-generating device 30. The transducer arrangement of each of the displacement sensors 42, 44 will generate an electric signal corresponding to the displacement of the respective plungers 50 of the displacement sensors 42, 44. These electric signals are transmitted to the controller 36 of the aerosol-generating device 30.

The controller 36 is configured to determine the measured hardness levels of the first and second sections 26, 28 of the front plug 20. In a next step the controller 36 determines the hardness difference between the first and second sections 26, 28 of the front plug 20. In a next step the controller 36 compares the determined hardness difference to reference data stored in a memory of the controller 36. If the determined hardness difference corresponds to the reference data, the controller 36 may determine that the respective aerosol-generating article 10 is an authentic article and normal operation of the device may be allowed. However, if the determined hardness difference does not fit with the reference data, the controller 36 may determine that the respective aerosol-generating article 10 is not an authentic article and further operation of the aerosol-generating device 30 may be terminated.

In addition to verifying, whether or not the inserted aerosol-generating article 10 is an authentic article or not, the controller 36 may be configured to identify a specific type of the aerosol-generating article 10. For this purpose, specific types of aerosol-generating articles 10 may be manufactured to have a front plug 20 with a specific hardness or a front plug with two sections having a specific hardness difference. The controller 36 is configured to determine the type of the inserted aerosol-generating article 10, by comparing the measured hardness values to a plurality of data sets stored in the controller's 36 memory. The controller 36 further comprises a database of pre-stored heating profiles for each type of aerosol-generating article. When the user initiates aerosol generation, the controller 36 is configured to provide power to the heating element 34 according to the specific heating profile for the inserted type of aerosol-generating article 10. In this way power supply to the heating element 34 may be tailored to the configuration of the specific type of aerosol-generating article 10. Aerosol-generation and the user experience may thus be optimized.

In FIG. 6 an alternative transducer arrangement based on a capacitive measurement is illustrated. This transducer arrangement is particularly applicable for embodiments with two displacement sensors 42, 44.

In this transducer arrangement, the two displacement sensors 42, 44 are working as capacitive transducers to measure the capacitive change between the two displacement sensors 42, 44. The working principle of the capacitive measurement is based on the capacitance of two parallel conductors 74, 76. The capacitance C of two parallel conductors 74, 76 having an overlapping area A and separated by a distance D, is defined by the equation C=ϵoϵrA/D.

As shown in FIG. 6, the overlapping area A between the conductors 74, 76 is highest if they are arranged in parallel as depicted in the left-hand view of FIG. 6. Upon relative displacement of the two conductors 74, 76, the overlapping area A is decreased, which in turn reduces the capacitance C of the system.

In correspondence thereto, when the sensing circuitry of the controller 36 applies a given voltage across the two displacement sensors 42, 44, the initial capacitance C between the two fully extended displacement sensors 42, 44 is highest and is measured by the sensing circuitry of the controller 36. Upon insertion of an aerosol-generating article 10 having a front plug 20 with two sections 26, 28 of different hardness, the plungers 50 of the two displacement sensors 42, 44 may be displaced to a different extent. In this way the overlapping area A of the two displacement sensors 42, 44 is reduced. As a result, the capacitance C between the two displacement sensors 42, 44 is equally decreased. Thus, the change in the measured capacitance C can be used as a measure for the hardness difference of the two sections 26, 28 of the front plug 20 of an aerosol-generating article 10. As described above the controller 36 may analyze the hardness difference and may control operation of the aerosol-generating device 30 accordingly.

1.-15. (canceled)

16. An aerosol-generating device, comprising:
a cavity configured to receive an aerosol-generating article comprising an aerosol-forming substrate, and
a hardness detector configured to detect a hardness of a portion of the aerosol-generating article,
wherein the portion of the aerosol-generating article comprises a front plug, and
wherein the hardness detector is further configured to detect a hardness of a portion of the front plug along a longitudinal axis of the front plug of the aerosol-generating article.

17. The aerosol-generating device according to claim 16, wherein the hardness detector comprises one or more displacement sensors.

18. The aerosol-generating device according to claim 16, wherein the hardness detector comprises two displacement sensors.

19. The aerosol-generating device according to claim 17, wherein the one or more displacement sensors are configured to each contact a portion of the front plug of the aerosol-generating article, when the aerosol-generating article is received in the cavity of the aerosol-generating device.

20. The aerosol-generating device according to claim 16, wherein the hardness detector is further configured to engage with a front face of the front plug at the distal end of the aerosol-generating article, when the aerosol-generating article is received in the cavity of the aerosol-generating device.

21. The aerosol-generating device according to claim 17, wherein each of the one or more displacement sensors comprise a body, a spring, and a plunger.

22. The aerosol-generating device according to claim 21, wherein the plunger of each of the one or more displacement sensors is configured as an indenter to penetrate the front plug of the inserted aerosol-generating article.

23. The aerosol-generating device according to claim 17, wherein a sensing system comprises a transducer arrangement to convert the displacement of each of the one or more displacement sensors into an electric signal corresponding to the penetration depth of each displacement sensor.

24. The aerosol-generating device according to claim 17, wherein a sensing system comprises a transducer arrangement configured to convert a displacement of each of the one or more displacement sensors into an electric signal corresponding to a penetration depth of each displacement sensor.

25. The aerosol-generating device according to claim 4, wherein the transducer arrangement includes a sensing coil arranged around said each displacement sensor and a magnet provided at the plunger of said each displacement sensor.

26. An aerosol-generating article, comprising:
an aerosol-forming substrate in an aerosol-forming substrate portion; and
a substrate wrapper at least partly circumscribing the aerosol-forming substrate portion,
wherein a portion of the aerosol-generating article comprises a front plug and is formed to have a predefined hardness along a longitudinal axis of the front plug of the aerosol-generating article.

27. The aerosol-generating article according to claim 26, wherein the front plug of the aerosol-generating article is formed from filter material.

28. The aerosol-generating article according to claim 26,
further comprising a front plug,
wherein the front plug has two portions with different hardness.

29. The aerosol-generating article according to claim 27, wherein the two portions of the front plug are placed in a concentric arrangement along the longitudinal axis of the aerosol-generating article.

30. An aerosol-generating system comprising the aerosol-generating device according to claim 16 and an aerosol-generating article comprising an aerosol-forming substrate in an aerosol-forming substrate portion and a substrate wrapper at least partly circumscribing the aerosol-forming substrate portion, wherein a portion of the aerosol-generating article comprises a front plug and is formed to have a predefined hardness along a longitudinal axis of the front plug of the aerosol-generating article.

31. The aerosol-generating system according to claim 30,
wherein the aerosol-generating article further comprises the front plug with two portions with different hardness, and
wherein the two portions with different hardness are configured to make contact to two displacement sensors of the aerosol-generating device, when the aerosol-generating article is received in the cavity of the aerosol-generating device.

32. A method for identifying an aerosol-generating article in an aerosol-generating device, the method comprising:
detecting, by a hardness detector, a hardness of a portion of a front plug of the aerosol-generating article along a longitudinal axis of the front plug of the aerosol-generating article.

33. The method according to claim 32, further comprising identifying the aerosol-generating article by determining a difference between a hardness of a first portion and a hardness of a second portion of the front plug of the aerosol-generating article and by comparing a hardness difference with reference data.

34. The method according to claim 32, further comprising:
controlling operation of the aerosol-generating device,
wherein one or more of:
controlling the operation of the aerosol-generating device includes choosing a heating profile of the aerosol-generating device depending upon a hardness detector output, and
controlling the operation of the aerosol-generating device includes deactivating operation of the aerosol-generating device if an unauthorized aerosol-generating article is detected.
